(19) United States
(12) Patent Application Publication
(10) Pub. No.: US 2006/0023452 A1
(43) Pub. Date: Feb. 2, 2006

(54) Scanning illumination module

(76) Inventor: Kuo-Yen Lai, Hsin-Chu (TW)

Correspondence Address: HungChang LIN, 8 Schindler Ct., Silver Spring, MD, 20903, US

(21) Appl. No.: 10/899,762

(22) Filed: Jul. 28, 2004

(51) Int. Cl. F21V 33/00

(52) U.S. Cl. 362/253

(57) ABSTRACT

A flood light is produced by rotating a divergent reflector or a divergent lens with respect to a light source to produce a flood light at a rate faster then the retention rate of human perception so that the flood light appears to be steady. The assembly of the light source, moving reflector or lens and the driving motor can be enclosed in a conventional light bulb. Alternatively, the light source can be rotated with respect to a fixed ring-shaped convex reflector or ring-shaped convex lens to produce the steady flood light.

### BACKGROUND OF THE INVENTION

1. Field of the Invention

This invention relates to light source, particularly to a flood light from a scanning light source.

2. Brief Description of Related Art

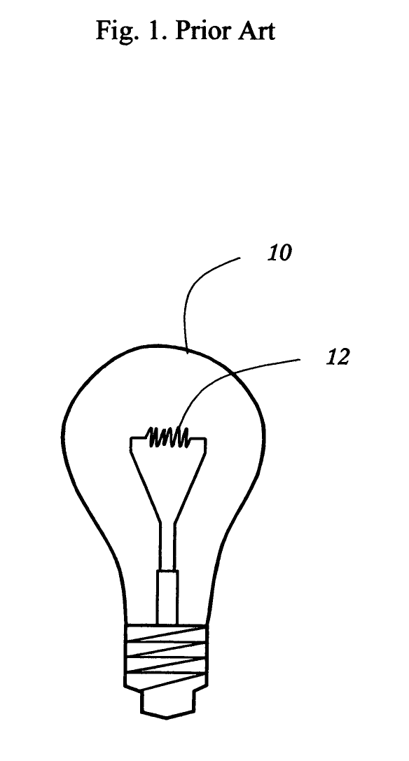

In a traditional light bulb as shown in FIG. 1, a glass shell covers a filament, which is energized by electrical current. Such a light bulb is inefficient and produces a large amount of heat.

### SUMMARY OF THE INVENTION

An object of this invention is to produce a flood light to increase the illumination area from a narrow light source. Another object of this invention is to provide a scanning light in a conventional light bulb shell Still another object is to increase the illumination efficiency of a light bulb.

These objects are obtained by scanning a narrow light source to increase the illumination area and utilizing the light retention characteristic of a human being to have the illusion that the light source is continuous. The scanning light source is obtained by rotating the narrow light source through a contoured mirror or lens to fan out the light beam The scanning light source can be installed inside a conventional light bulb shell to replace a conventional light bulb for lighting or decoration.

FIG. 1 shows a conventional light bulb.

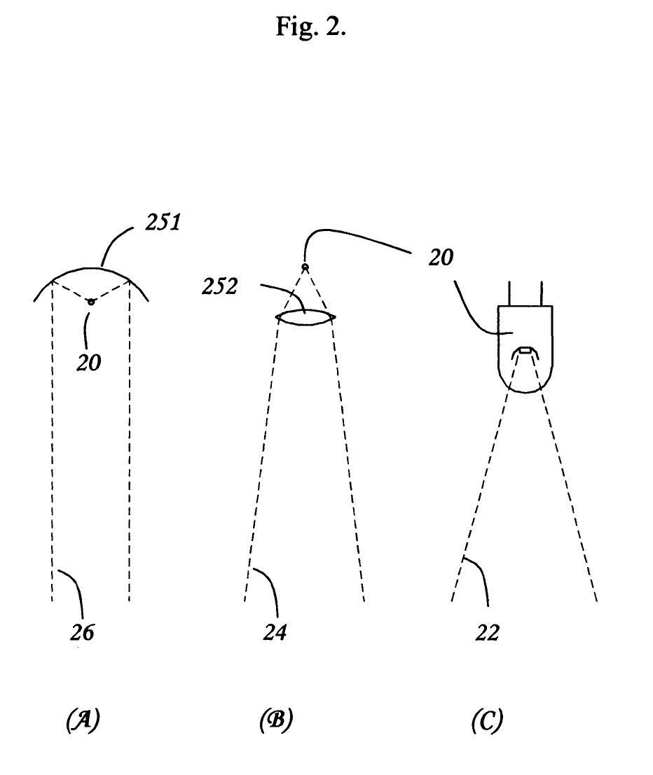

FIG. 2 shows flood light from a point light source using (A) a reflecting arc mirror, (B) a convex lens, and (C) direct illumination.

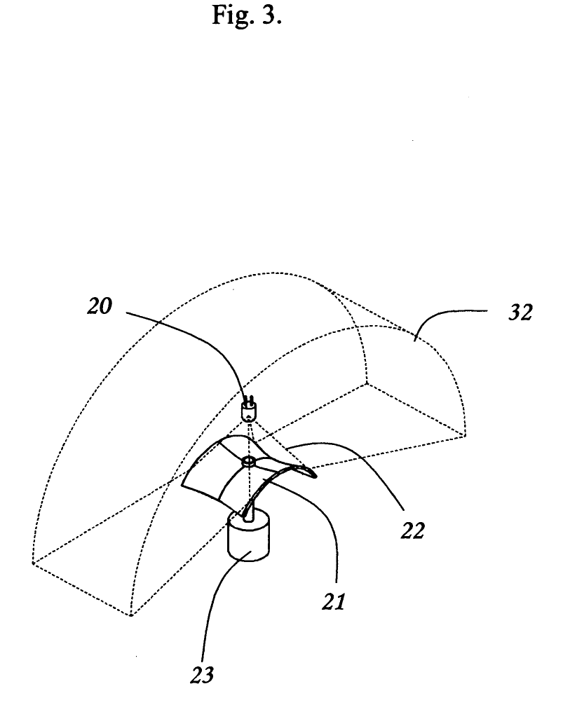

FIG. 3 shows a rotating convex reflector for fanning the light.

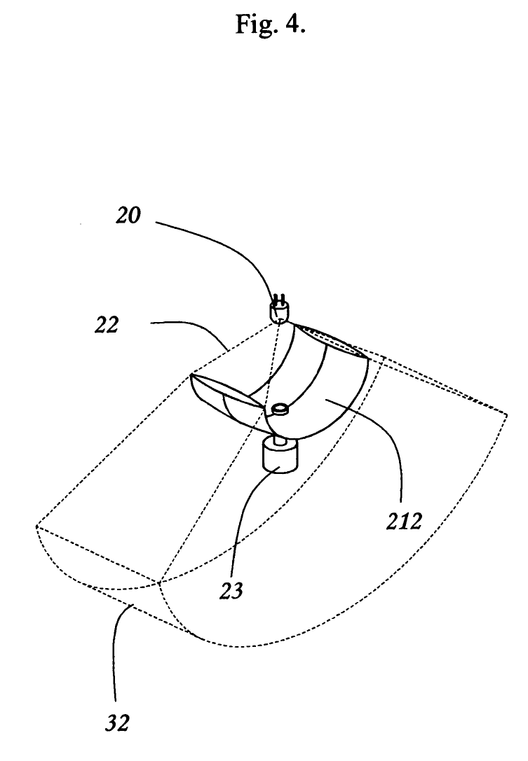

FIG. 4 shows a rotating concave lens for fanning the light.

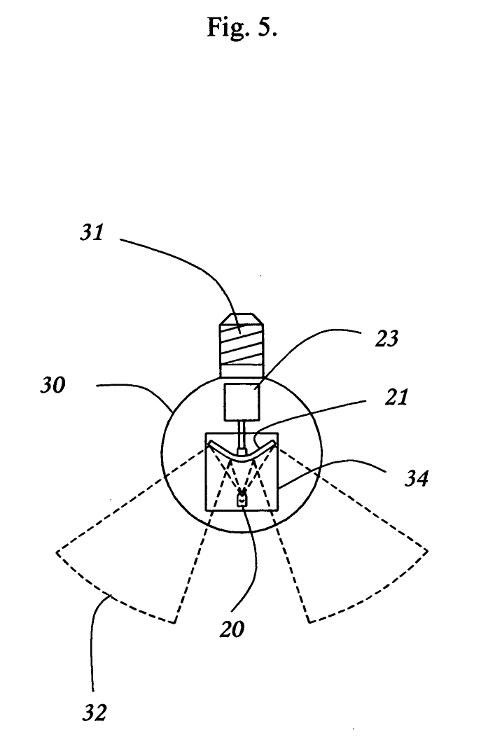

FIG. 5 shows a rotating convex reflector and a driving motor installed inside a glass light bulb shell.

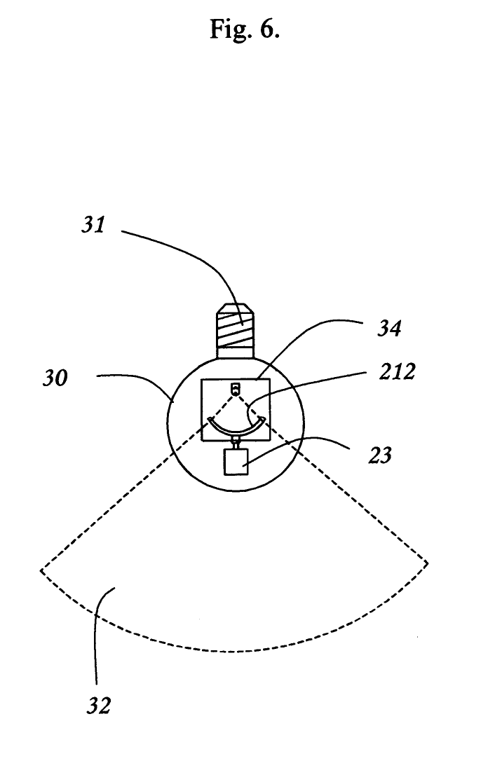

FIG. 6 shows a rotating concave lens and driving motor installed inside a glass light bulb shell.

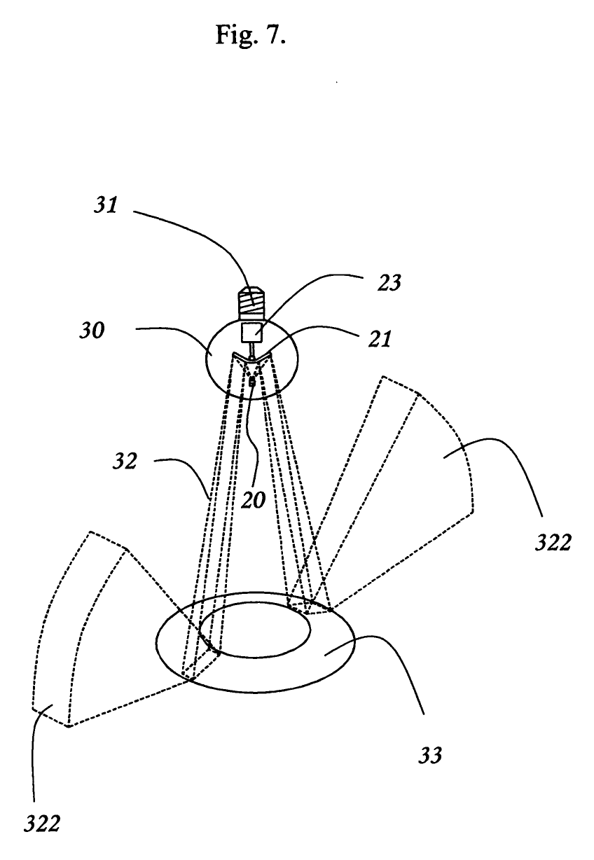

FIG. 7 shows a light bulb shown in FIG. 5 illuminating a reflecting ring to further increase the fan-out area.

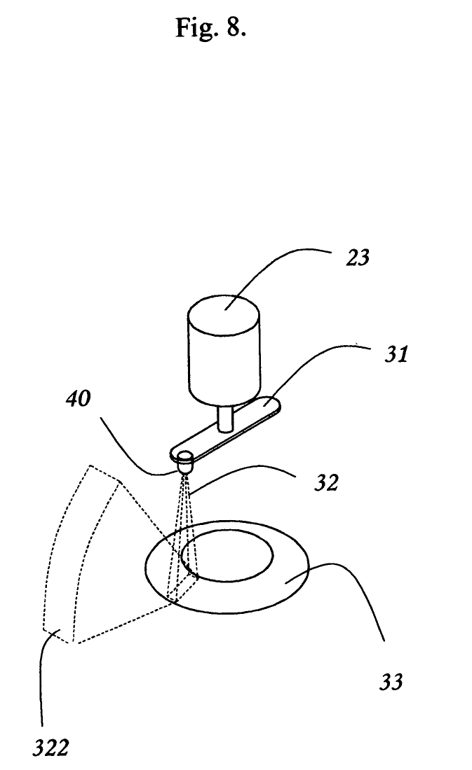

FIG. 8 shows a rotating light source illuminating a reflecting ring to fan out the reflecting light.

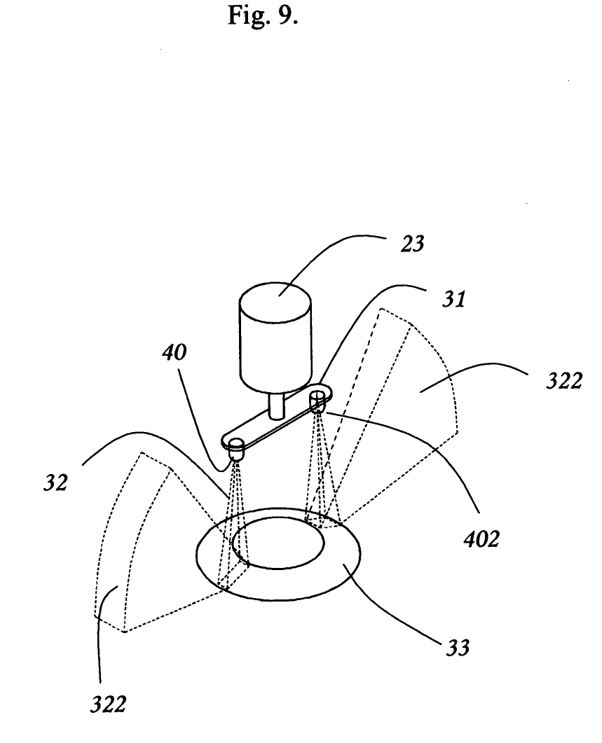

FIG. 9 shows two rotating light sources illuminating a reflecting ring to fan out the reflecting light.

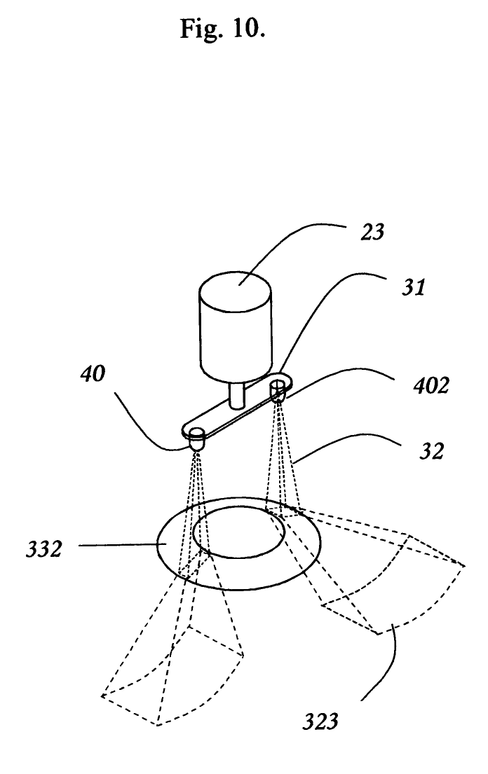

FIG. 10 shows two rotating light sources illuminating a ring-shaped lens to fan-out the light.

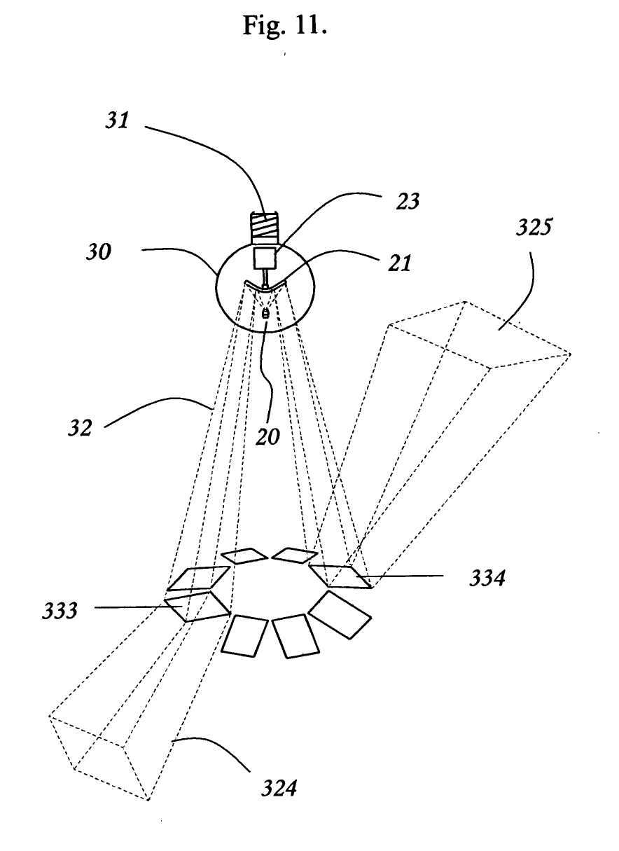

FIG. 11 shows a light bulb shown in FIG. 5 illuminating segmented reflectors and lenses in a ring.

### DETAILED DESCRIPTION OF THE INVENTION

FIG. 2 shows the principal divergence of light a light source. In (A), the light source 20 is reflected by a concave arc 251, the light reflected by the reflecting arc form a wide light beam 26. In (B), the light source 20 is transmitted through a convex lens 252 to form a divergent light beam 24. In (C), the light source is a light emitting device 20, emits a divergent light beam 22. The three types of light sources can be used as a primary light source for this invention. Only type (C) is used in the following embodiments as an example.

FIG. 3 shows the basic structure of the present invention. The light source 20 emits a light beam 22 and is reflected by a rotating convex surface 21 to fan out a flood light 32. The convex surface is driven by a motor 23 at a speed higher than the retention rate of human vision, so that the flood light appears steady.

FIG. 4 shows a second embodiment of the present invention. The structure is similar to that in FIG. 3 except that a rotating convex lens 212 is used in place of the rotating reflector in FIG. 3. The rotating lens 212 fans out a flood light 32. The light source 20, the light beam 22 and the motor 23 serve the same functions as in FIG. 3.

FIG. 5 shows a third embodiment of the present invention. A rotating flood light module 34 as shown in FIG. 3 is installed inside a standard light bulb shell 30 with a standard screw-on plug 31 for insertion into a standard socket. The reference numerals 20, 21 and 32 refer to the same corresponding parts in FIG. 3.

FIG. 6 shows a fourth embodiment of the present invention. A rotating flood light module 34 shown in FIG. 4 is installed inside a standard light bulb 30 with a standard screw-on plug 31 for insertion into a standard socket. The reference numerals 212, 23 and 32 refer to the same corresponding parts in FIG. 4.

FIG. 7 shows a fifth embodiment of the present invention. The structure is to further increase of the fan-out of the light emitted from the light bulb shown in FIG. 5. The light beams 32 from the light bulb 30 is reflected by a reflecting ring 33 which fans out a flood light 322 and covers an area larger than that covered by the light beam 32 from the light bulb 30. The reference numerals 20, 21, 23, 30 and 31 refer to the same corresponding parts in FIG. 5. The reflecting ring can also be replaced by a convex ring-shaped lens, which then can fan-out a divergent flood light below the convex lens.

FIG. 8 shows a sixth embodiment of the present invention. A light source 40 is rotated on the rotating arm 31 driven by a motor 23. The light beam 32 is reflected by a convex ring 33 to fan out the light beam 32 as a flood light 322. The rotating light beam 32 is rotated at a higher speed than the retention rate of human perception so that the flood light spears steady.

FIG. 9 shows a seventh embodiment of the present invention. The structure is similar to that in FIG. 8 except that an additional light source 402 is placed diametrically opposite in the rotating arm 31. By doubling the number of light source, the flood light intensity is increased. Other reference numerals refer to the same corresponding parts in FIG. 8.

FIG. 10 shows an eighth embodiment of the present invention The structure is similar to that in FIG. 9 except that the reflecting ring is replaced by a convex ring-shaped lens 332. The lens produces a divergent flood light 323 below that lens 332.

FIG. 11 shows the ninth embodiment of the present invention. The structure is similar to that in FIG. 7 and FIG. 8 except that the reflecting ring is segmented with reflectors 334 and interposed with segmented convex lenses 333. The segmented reflecting ring produces a divergent flood light 325 above the reflecting ring 334, and the segmented lens produces a divergent flood light 324 below the ring-shaped lens 333. Thus the flood light cover a larger area than that in FIG. 7 or FIG. 8. Other reference numerals refer to the corresponding parts in FIG. 7 and FIG. 8.

While the preferred embodiments have been described, it will be apparent to those skilled in the art that various modifications can be made without departing from the spirit of the present invention Such modifications are all within the scope of the present invention.

1. A scanning flood light, comprising:
at least one light source to generate a light beam;
optical means to divert said light beam; and
means to rotating said optical means to produce a flood light at a speed higher that the retention rate of human perception so that the flood light appears steady.

2. The scanning flood light as described in claim 1, wherein said optical means is a reflecting surface and the means to rotate is a motor.

3. The scanning flood light as described in claim 1, wherein said optical means is a convex lens and the means to rotate is a motor.

4. The scanning flood light as described in claim 2, wherein said reflecting surface is a convex arc.

5. The scanning flood light as described in claim 3, wherein said convex lens is of arc shape.

6. The scanning flood light as described in claim 2, further comprising a glass bulb to enclose said light source, said reflecting surface and said motor, and a screw-on plug for inserting into a socket.

7. The scanning flood light as described in claim 3, further comprising a glass bulb to enclose said light source, said convex lens and said motor, and a screw-on plug for inserting into a socket.

8. The scanning flood light as described in claim 6, further comprising a reflecting ring to fan out the flood light.

9. The scanning flood light as described in claim 7, further comprising a ring-shaped convex lens to fan out the flood light.

10. A scanning flood light, comprising:
at least one light source for generating light beam;
a rotating arm for mounting said light source and driven by a motor at a speed faster than the retention rate of human vision; and
an optical means for diverting said light beam into a steady flood light.

11. The scanning flood light as described in claim 10, wherein there are two of said light source.

12. The scanning flood light as described in claim 11, wherein said optical means is a convex reflecting ring.

13. The scanning flood light as described in claim 11, wherein said optical means is a convex ring-shaped lens.

14. The scanning flood light as described in claim 11, wherein said optical means comprises segments in a ring, selected from the group consisted of reflector and lens.
